(19) United States
(12) Patent Application Publication
(10) Pub. No.: US 2026/0074295 A1
(43) Pub. Date: Mar. 12, 2026

(54) ELECTRODE ASSEMBLY FOR SECONDARY BATTERY AND METHOD FOR MANUFACTURING THE SAME

(71) Applicant: SAMSUNG SDI CO., LTD., Yongin-si (KR)

(72) Inventor: Dong Yun HAN, Yongin-si (KR)

(21) Appl. No.: 19/086,380

(22) Filed: Mar. 21, 2025

(30) Foreign Application Priority Data
Sep. 12, 2024 (KR) 10-2024-0124445

(51) Int. Cl. H01M 10/0585; H01M 4/70

(52) U.S. Cl. CPC H01M 10/0585; H01M 4/70

(57) ABSTRACT

An electrode assembly for a secondary battery includes a first electrode plate with a first electrode pattern part, the first electrode pattern part including a plurality of patterns, a second electrode plate with a second electrode pattern part, the second electrode being stacked on at least one surface of the first electrode plate, and the second electrode pattern part including a plurality of patterns corresponding to positions and shapes of the plurality of patterns of the first electrode pattern part, and a separator between the first electrode plate and the second electrode plate.

### CROSS-REFERENCE TO THE RELATED APPLICATION

The present application claims priority to and the benefit of Korean Patent Application No. 10-2024-0124445, filed on Sep. 12, 2024, in the Korean Intellectual Property Office, the entire disclosure of which is incorporated herein by reference.

### BACKGROUND

### 1. Field

Embodiments relate to an electrode assembly for a secondary battery and a method for manufacturing the same.

### 2. Description of the Related Art

Unlike primary batteries that are not designed to be (re)charged, secondary (or rechargeable) batteries are batteries that are designed to be discharged and recharged. Low-capacity secondary batteries are used in portable, small electronic devices, such as smart phones, feature phones, notebook computers, digital cameras, and camcorders, while large-capacity secondary batteries are widely used as power sources for driving motors in hybrid vehicles and electric vehicles and for storing power (e.g., home and/or utility scale power storage). A secondary battery generally includes an electrode assembly composed of a positive electrode and a negative electrode, a case accommodating the same, and electrode terminals connected to the electrode assembly.

An electrode assembly may be structurally designed so that a positive and negative electrode plates are aligned to be stacked. The alignment of the electrode plates may affect internal efficiency of a secondary battery and overall performance of the secondary battery. The alignment of the electrode plates may be managed by a high-precision robot and an optical camera for alignment inspection.

The above information disclosed in this Background section is for enhancement of understanding of the background of the present disclosure, and therefore, it may contain information that does not constitute related (or prior) art.

### SUMMARY

According to some embodiments, an electrode assembly for a secondary battery includes a first electrode plate; a second electrode plate stacked on one surface or both surfaces of the first electrode plate; and a separator disposed between the first electrode plate and the second electrode plate, wherein the first electrode plate includes a first electrode pattern part on which a plurality of patterns are disposed, and the second electrode plate includes a second electrode pattern part on which a plurality of patterns are disposed to correspond to positions and shapes of the plurality of patterns of the first electrode pattern part.

The separator may be pressed between the first electrode plate and the second electrode plate to correspond to the patterns of the first electrode pattern part and the second electrode pattern part.

Each of the first electrode pattern part and the second electrode pattern part may include an uneven pattern.

The first electrode pattern part and the second electrode pattern part may include a plurality of concave portions and a plurality of convex portions, respectively.

Each of the plurality of concave portions and the plurality of convex portions may have a shape of at least one of a semicircle, an oval, a triangle, a square, or a polygon.

Each of the plurality of concave portions and the plurality of convex portions may have a shape in which at least two of a semicircle, an oval, a triangle, a square, or a polygon are mixed.

The first electrode pattern part and the second electrode pattern part may include a plurality of concave patterns or a plurality of convex patterns, respectively.

Each of the first electrode pattern part and the second electrode pattern part may be provided in a shape in which a plurality of patterns are continuously disposed.

Each of the first electrode pattern part and the second electrode pattern part may be provided in a shape in which a plurality of patterns are spaced apart from each other.

The plurality of patterns spaced apart from each other of each of the first electrode pattern part and the second electrode pattern part may have shapes different from each other.

A depth of each of the patterns of the first electrode pattern part and the second electrode pattern part may be about 10% to about 15% of a thickness of each of the first electrode plate and the second electrode plate.

According to some embodiments, a method for manufacturing an electrode assembly for a secondary battery includes a cutting process of cutting a first electrode plate and a second electrode plate in each of a first base material and a second base material; a press process of providing a first electrode pattern part and a second electrode pattern part, each of which has a plurality of patterns on each of the first electrode plate and the second electrode plate; a stacking process of providing the second electrode plate on one surface or both surfaces of the first electrode plate and inserting a separator between the first electrode plate and the second electrode plate to stack the first electrode plate, the second electrode plate, and the separator, wherein the first electrode pattern part and the second electrode pattern part correspond to each other in position and shape of the plurality of patterns.

In the press process, a plurality of uneven patterns may be provided on each of the first electrode pattern part and the second electrode pattern part.

The first electrode pattern part and the second electrode pattern part may include a plurality of concave portions and a plurality of convex portions, respectively.

Each of the plurality of concave portions and the plurality of convex portions may have a shape of at least one of a semicircle, an oval, a triangle, a square, or a polygon.

Each of the plurality of concave portions and the plurality of convex portions may have a shape in which at least two of a semicircle, an oval, a triangle, a square, or a polygon are mixed.

In the press process, a plurality of concave patterns or a plurality of convex patterns may be provided in/on each of the first electrode pattern part and the second electrode pattern part.

In the press process, a plurality of patterns may be continuously formed on each of the first electrode pattern part and the second electrode pattern part.

In the press process, a plurality of patterns may be formed to be spaced apart from each other on each of the first electrode pattern part and the second electrode pattern part.

In the press process, pressing may be performed so that a depth of each of the patterns of the first electrode pattern part and the second electrode pattern part is about 10% to about 15% of a thickness of each of the first electrode plate and the second electrode plate.

### BRIEF DESCRIPTION OF THE DRAWINGS

The following drawings attached to this specification illustrate embodiments of the present disclosure, and further describe aspects and features of the present disclosure together with the detailed description of the present disclosure. Thus, the present disclosure should not be construed as being limited to the drawings:

FIG. 1 illustrates a perspective view of a structure of a secondary battery according to embodiments;

FIG. 2 illustrates a vertical cross-sectional view of a long side of an electrode assembly of FIG. 1;

FIGS. 3 to 8 illustrate a vertical cross-sectional view of a long side in various shapes of a pattern part of the electrode assembly according to various embodiments;

FIG. 9 illustrates a flowchart of a method for manufacturing an electrode assembly according to embodiments;

FIG. 10 illustrates a view for explaining a method for manufacturing the electrode assembly according to embodiments;

FIG. 11 is a view schematically showing a smartphone equipped with a secondary battery according to an embodiment of the present disclosure;

FIG. 12 is a perspective view illustrating a secondary battery according to one or more embodiments of the present disclosure;

FIG. 13 is a cross-sectional view taken along the line II-II in FIG. 12;

FIG. 14 is a perspective view illustrating a battery module according to one or more embodiments of the present disclosure;

FIGS. 15A and 15B illustrate perspective views of an example of a battery pack; and

FIGS. 16A and 16B illustrate perspective and side views of examples of a vehicle body and a vehicle components.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

In the drawing figures, the dimensions of layers and regions may be exaggerated for clarity of illustration. It will also be understood that when a layer or element is referred to as being “on” another layer or substrate, it can be directly on the other layer or substrate, or intervening layers may also be present. In addition, it will also be understood that when a layer is referred to as being “between” two layers, it can be the only layer between the two layers, or one or more intervening layers may also be present. Like reference numerals refer to like elements throughout.

Hereinafter, embodiments of the present disclosure will be described, in detail, with reference to the accompanying drawings. The terms or words used in this specification and claims should not be construed as being limited to the usual or dictionary meaning and should be interpreted as meaning and concept consistent with the technical idea of the present disclosure based on the principle that the inventor can be his/her own lexicographer to appropriately define the concept of the term to explain example embodiments in the best way.

The embodiments described in this specification and the configurations shown in the drawings are only some of the embodiments of the present disclosure and do not represent all of the technical ideas, aspects, and features of the present disclosure. Accordingly, it should be understood that there may be various equivalents and modifications that can replace or modify the embodiments described herein at the time of filing this application.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112(a) and 35 U.S.C. § 132(a).

References to two compared elements, features, etc. as being “the same” may mean that they are “substantially the same”. Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

Throughout the specification, unless otherwise stated, each element may be singular or plural.

When an arbitrary element is referred to as being disposed (or located or positioned) on the “above (or below)” or “on (or under)” a component, it may mean that the arbitrary element is placed in contact with the upper (or lower) surface of the component and may also mean that another component may be interposed between the component and any arbitrary element disposed (or located or positioned) on (or under) the component.

In addition, it will be understood that when an element is referred to as being “coupled,” “linked” or “connected” to another element, the elements may be directly “coupled,” “linked” or “connected” to each other, or an intervening element may be present therebetween, through which the element may be “coupled,” “linked” or “connected” to another element. In addition, when a part is referred to as being “electrically coupled” to another part, the part can be directly connected to another part or an intervening part may be present therebetween such that the part and another part are indirectly connected to each other.

Throughout the specification, when “A and/or B” is stated, it means A, B or A and B, unless otherwise stated. That is, “and/or” includes any or all combinations of a plurality of items enumerated. When “C to D” is stated, it means C or more and D or less, unless otherwise specified.

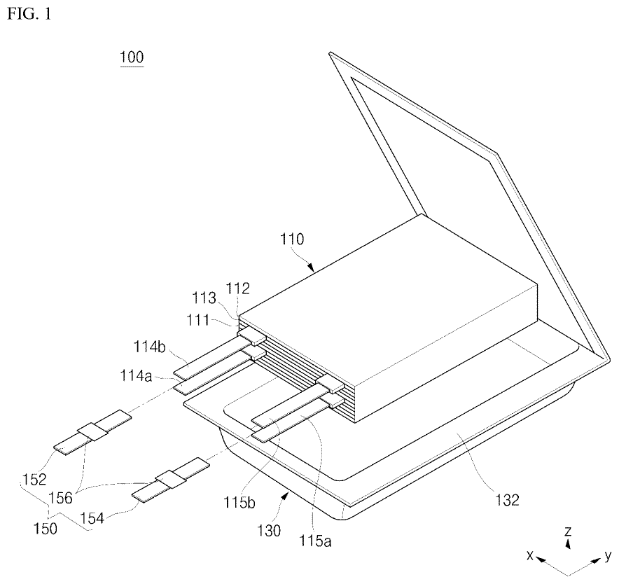

FIG. 1 is a perspective view showing the structure of a secondary battery according to an embodiment.

As shown in FIG. 1, the secondary battery 100 includes an electrode assembly 110 and a pouch 130 accommodating the electrode assembly 110.

The electrode assembly 110 includes a negative electrode plate 111 as a first electrode plate, a positive electrode plate 112 as a second electrode plate, and a separator 113 interposed therebetween. In some embodiments, an electrode assembly may be provided by stacking the negative electrode plate 111, the separator 113, and the positive electrode plate 112, each of which is provided in a thin plate shape or film shape. In some examples, one or more electrode assemblies 110 may be stacked such that the electrode assemblies 110 are adjacent to each other and accommodated in the pouch 130, and the number of electrode assemblies 110 in the case is not limited in the present disclosure. The first electrode plate 111 of the electrode assembly 110 may act as a negative electrode, and the second electrode plate 112 may act as a positive electrode. Of course, the reverse is also possible.

The negative electrode plate 111 may be formed by applying a first electrode active material, such as graphite or carbon, to a first electrode current collector formed of a metal foil, such as copper, a copper alloy, nickel, or a nickel alloy. The negative electrode plate 111 may include a first electrode active material layer that is a region to which the first electrode active material is applied. The negative electrode plate 111 may include a first uncoated portion that is a region to which the first electrode active material is not applied.

The negative electrode plate 111 may include negative electrode tabs 114a and 114b electrically connected to the first uncoated portion. In some embodiments, the negative electrode tabs 114a and 114b may be fixed (e.g., welded) to a negative electrode non-coating portion in a generally flat shape. For example, the negative electrode tabs 114a and 114b may be fixed to the negative electrode non-coating portion by ultrasonic welding, laser welding, or resistance welding. That is, one end of the negative electrode tab 114a may be electrically connected to the negative electrode non-coating portion, and the other end may protrude and extend to the outside. In some embodiments, when the negative electrode plate 111 is manufactured, the negative electrode tabs 114a and 114b may be formed by being cut in advance to protrude to one side of the electrode assembly 110, or the negative electrode tabs 114a and 114b may protrude to one side of the electrode assembly 110 more than (e.g., farther than or beyond) the separator 113 without being separately cut.

The negative electrode active material, which is the first active material, may include a material capable of reversibly intercalating/deintercalating lithium ions, lithium metal, an alloy of lithium metal, a material capable of being doped and dedoped with lithium, or a transition metal oxide.

The material capable of reversibly intercalating/deintercalating lithium ions may be a carbon-based negative electrode active material, which may include, for example, crystalline carbon, amorphous carbon, or a combination thereof. Examples of the crystalline carbon may include graphite, such as natural graphite or artificial graphite, and examples of the amorphous carbon may include soft carbon, hard carbon, a pitch carbide, a meso-phase pitch carbide, sintered coke, and the like.

A Si-based negative electrode active material or a Sn-based negative electrode active material may be used as the material capable of being doped and dedoped with lithium. The Si-based negative electrode active material may be silicon, a silicon-carbon composite, SiOₓ (0<x<2), a Si-based alloy, or a combination thereof.

The silicon-carbon composite may be a composite of silicon and amorphous carbon. According to one embodiment, the silicon-carbon composite may be in the form of a silicon particle and amorphous carbon coated on the surface of the silicon particle.

The silicon-carbon composite may further include crystalline carbon. For example, the silicon-carbon composite may include a core including crystalline carbon and silicon particle and an amorphous carbon coating layer on the surface of the core.

A negative electrode for a lithium secondary battery may include a current collector and a negative electrode active material layer disposed on the current collector. The negative electrode active material layer may include a negative electrode active material and may further include a binder and/or a conductive material.

For example, the negative electrode active material layer may include about 90 wt % to about 99 wt % of a negative electrode active material, about 0.5 wt % to about 5 wt % of a binder, and about 0 wt % to about 5 wt % of a conductive material.

A non-aqueous binder, an aqueous binder, a dry binder, or a combination thereof may be used as the binder. When an aqueous binder is used as the negative electrode binder, a cellulose-based compound capable of imparting viscosity may be further included.

As the negative electrode current collector, one selected from copper foil, nickel foil, stainless steel foil, titanium foil, nickel foam, copper foam, conductive metal-coated polymer substrate, and combinations thereof may be used.

An electrolyte for a lithium secondary battery may include a non-aqueous organic solvent and a lithium salt.

The non-aqueous organic solvent acts as a medium through which ions involved in the electrochemical reaction of the battery can move.

The non-aqueous organic solvent may be a carbonate-based, an ester-based, an ether-based, a ketone-based, an alcohol-based solvent, an aprotic solvent, and may be used alone or in combination of two or more.

In addition, when a carbonate-based solvent is used, a mixture of cyclic carbonate and chain carbonate may be used.

The positive electrode plate 112 may be formed by applying a second electrode active material, such as a transition metal oxide, on a second electrode current collector formed of a metal foil, such as aluminum or an aluminum alloy. The positive electrode plate 112 may include a second electrode active material layer that is a region to which the second electrode active material is applied. The positive electrode plate 112 may include a second uncoated portion that is a region to which the second electrode active material is not applied.

The positive electrode plate 112 may include positive electrode tabs 115a and 115b electrically connected to the second uncoated portion. In some embodiments, the positive electrode tabs 115a and 115b may be fixed (e.g., welded) to a positive electrode non-coating portion in a generally flat shape. For example, the positive electrode tabs 115a and 115b may be fixed to the positive electrode non-coating portion by ultrasonic welding, laser welding, or resistance welding. That is, one end of the positive electrode tab 115a may be electrically connected to the positive electrode non-coating portion, and the other end may protrude and extend to the outside. In some embodiments, when the positive electrode plate 112 is manufactured, the positive electrode tabs 115a and 115b may be formed by being cut in advance to protrude to one side of the electrode assembly 110, or the positive electrode tabs 115a and 115b may protrude to one side of the electrode assembly 110 more than (e.g., farther than or beyond) the separator 113 without being separately cut.

As the positive electrode active material, which is the second active material, a compound capable of reversibly intercalating/deintercalating lithium (e.g., a lithiated intercalation compound) may be used. For example, at least one of a composite oxide of lithium and a metal selected from cobalt, manganese, nickel, and combinations thereof may be used.

The composite oxide may be a lithium transition metal composite oxide, and examples thereof may include a lithium nickel-based oxide, a lithium cobalt-based oxide, a lithium manganese-based oxide, a lithium iron phosphate-based compound, a cobalt-free nickel-manganese-based oxide, or a combination thereof.

As an example, a compound represented by any one of the following formulas may be used: LiₐA_{1-b}X_{b}O_{2-c}D_{c} (0.90≤a≤1.8, 0<b<0.5, 0<c<0.05); LiₐMn_{2-b}X_{b}O_{4-c}D_{c} (0.90≤a≤1.8, 0≤b≤0.5, 0≤c≤0.05); LiₐNi_{1-b-c}Co_{b}X_{c}O_{2-α}D_{α} (0.90≤a≤1.8, 0≤b≤0.5, 0≤0.5, 0<α<2); LiₐNi_{1-b-c}Mn_{b}X_{c}O_{2-α}D_{α} (0.90≤a≤1.8, 0≤b≤0.5, 0≤c≤0.5, 0≤α≤2); LiₐNi_{b}Co_{c}L¹_{d}GₑO₂ (0.90≤a≤1.8, 0≤b≤0.9, 0≤c≤0.5, 0≤d≤0.5, 0≤e≤0.1); LiₐNiG_{b}O₂ (0.90≤a≤1.8, 0.001≤b≤0.1); LiₐCoG_{b}O₂ (0.90≤a≤1.8, 0.001≤b≤0.1); LiₐMn_{1-b}G_{b}O₂ (0.90≤a≤1.8, 0.001≤b≤0.1); LiₐMn₂G_{b}O₄ (0.90≤a≤1.8, 0.001≤b≤0.1); LiₐMn_{1-g}G_{g}PO₄ (0.90≤a≤1.8, 0≤g≤0.5); Li_{(3-f)}Fe₂(PO₄)₃(0≤f≤2); and LiₐFePO₄ (0.90≤a≤1.8).

In the above formulas: A is Ni, Co, Mn, or a combination thereof, X is Al, Ni, Co, Mn, Cr, Fe, Mg, Sr, V, a rare earth element, or a combination thereof, D is O, F, S, P, or a combination thereof, G is Al, Cr, Mn, Fe, Mg, La, Ce, Sr, V, or a combination thereof, and L¹ is Mn, Al, or a combination thereof.

A positive electrode for a lithium secondary battery may include a current collector and a positive electrode active material layer formed on the current collector. The positive electrode active material layer may include a positive electrode active material and may further include a binder and/or a conductive material.

The content of the positive electrode active material is in a range of about 90 wt % to about 99.5 wt % on the basis of 100 wt % of the positive electrode active material layer, and the content of the binder and the conductive material is in a range of about 0.5 wt % to about 5 wt %, respectively, on the basis of 100 wt % of the positive electrode active material layer.

The current collector may be aluminum (Al) but is not limited thereto.

In some embodiments, electrode leads 150 may be provided to electrically connect the negative electrode tabs 114a and 114b and the positive electrode tab 115a and 115b to the outside. The negative electrode tabs 114a and 114b and the positive electrode tabs 115a and 115b are respectively welded to a negative electrode lead 152 and a positive electrode lead 154 of an external terminal to be electrically connected to the outside. A tab film 156 for insulation from the pouch 130 is attached to the negative electrode lead 152 and the positive electrode lead 154. The pouch 130 may also be referred to as a case.

The separator 113 may be interposed between the negative electrode plate 111 and the positive electrode plate 112 to prevent electrical short-circuit between the negative electrode plate 111 and the positive electrode plate 112. In some embodiments, the separator 113 may be provided in a pair, and the negative electrode plate 111 may be sandwiched between the pair of separators 113.

Depending on the type of lithium secondary battery, the separator 113 may be present between the first electrode plate (e.g., the negative electrode) and the second electrode plate (e.g., the positive electrode). As the separator 113, polyethylene, polypropylene, polyvinylidene fluoride, or a multilayer film of two or more layers thereof may be used.

The separator 113 may include a porous substrate and a coating layer including an organic material, an inorganic material, or a combination thereof on one or both surfaces of the porous substrate.

The organic material may include a polyvinylidene fluoride-based polymer or a (meth)acrylic polymer.

The inorganic material may include inorganic particles selected from Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, and combinations thereof but is not limited thereto.

The organic material and the inorganic material may be mixed in one coating layer or may be in the form of a coating layer containing an organic material and a coating layer containing an inorganic material that are laminated on each other.

In a state in which the electrode assembly 110 is accommodated in the pouch 130, sealing parts 132 of edges of the pouch 130 come into contact with each other (e.g., the sealing parts 132 around the periphery of the bottom portion of the pouch 130 come into contact with a corresponding peripheral area of the top portion (e.g., a cover) of the pouch 130) to be sealed. The sealing is performed in a state in which the tab film 156 is disposed between the sealing parts 132. As shown in FIG. 1, the form in which the tab film 156 is attached to each of the negative electrode tabs 114a and 114b and the positive electrode tabs 115a and 115b is defined as a “separable tab film” (e.g., this sealing structure is referred to as a separable sealing structure).

The sealing parts 132 at the bottom portion of the pouch 130 as well as the top portion (e.g., the entire cover or at least the peripheral area of the cover) may be made of a heat-fusible material and may have a structure in which sealing is achieved by bonding heat-fusible layers to each other. Because the heat-fusible material generally has weak adhesion to metal, the tab film 156 in the form of a thin film is attached to a tab to be fused to the pouch 130. However, in the separable sealing structure, the tab film 156 is attached to the negative electrode lead 152 and the positive electrode lead 154 and then welded thereto, followed by being heat-fused with the pouch 130, and thus, workability and productivity may be improved. The pouch 130 may have an internal space and may accommodate the electrode assembly 110 in the internal space.

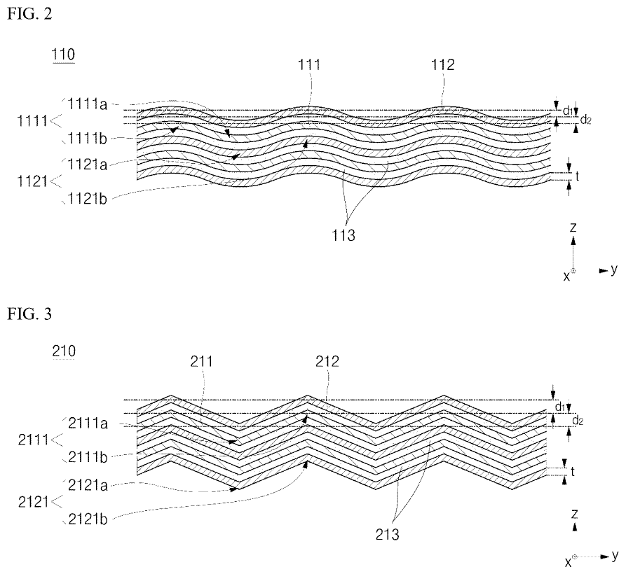

FIG. 2 illustrates a vertical cross-sectional view of a long side of the electrode assembly 110 of FIG. 1. FIGS. 3 to 8 illustrate a vertical cross-sectional view of a long side in various shapes of a pattern part of an electrode assembly according to various embodiments.

Referring to FIG. 2, the electrode assembly 110 may include the negative electrode plate 111, the positive electrode plate 112, and the separator 113. For example, referring to FIGS. 1 and 2, each of the negative electrode plate 111, the positive electrode plate 112, and the separator 113 within the electrode assembly 110 may include a pattern part having a predetermined shape (e.g., a part having a non-flat shape), as viewed in a cross-section from the yz-plane perspective (FIG. 2).

For example, referring to FIG. 2, the negative electrode plate 111 may include a negative electrode pattern part 1111 provided in a specific shape. In some embodiments, the negative electrode pattern part 1111 may be constituted by a plurality of patterns. Referring to FIG. 1, the negative electrode plate 111 may have a shape having a pair of short sides (e.g., extending in the x-axis direction) and a pair of long sides (e.g., extending in the y-axis direction). In some embodiments, the negative electrode pattern part 1111 may be a plurality of uneven patterns. The uneven patterns may include a plurality of concave portions 1111a recessed in a z-axis direction and a plurality of convex portions 1111b protruding in the z-axis direction if viewed in the vertical cross-section of the pair of long sides of the negative electrode plate 111. In some embodiments, the plurality of uneven patterns may be in the form of repeating semicircles in a wavy shape, e.g., the plurality of concave portions 1111a and the plurality of convex portions 1111b may alternate in the y-axis direction to define a continuous wave shape with curved peaks and valleys.

The positive electrode plate 112 may include a positive electrode pattern part 1121 provided in a specific shape. In some embodiments, the positive electrode pattern part 1121 may be constituted by a plurality of patterns. Referring to FIG. 1, the positive electrode plate 112 may have a shape having a pair of short sides (e.g., extending in the x-axis direction) and a pair of long sides (e.g., extending in the y-axis direction). In some embodiments, the positive electrode pattern part 1121 may have a plurality of uneven patterns. The uneven patterns may include a plurality of concave portions 1121a recessed in the z-axis direction and a plurality of convex portions 1121b protruding in the z-axis direction if viewed in the vertical cross-section of the pair of long sides of the positive electrode plate 112. In some embodiments, the plurality of uneven patterns may be in the form of repeating semicircles in a wavy shape, e.g., the plurality of concave portions 1121a and the plurality of convex portions 1121b may alternate in the y-axis direction to define a continuous wave shape with curved peaks and valleys.

In some embodiments, the negative electrode pattern part 1111 of the negative electrode plate 111 and the positive electrode pattern part 1121 of the positive electrode plate 112 may correspond to (e.g., overlap) each other in position and shape. In some embodiments, the negative electrode plate 111 and the positive electrode plate 112 may be stacked to overlap the negative electrode pattern part 1111 and the positive electrode pattern part 1121. In some embodiments, the separator 113 may be thermally compressed to correspond to the shapes of the negative electrode pattern part 1111 of the negative electrode plate 111 and the positive electrode pattern part 1121 of the positive electrode plate 112. For example, the separator 113 may be inserted between the negative electrode plate 111 and the positive electrode plate 112 in a substantially flat state and then deformed according to the shapes of the negative electrode plate 111 and the positive electrode plate 112 if stacked (or pressed).

In some embodiments, a depth (d₁, d₂) of each of the patterns in the z-axis direction of the negative electrode pattern part 1111 of the negative electrode plate 111 and the positive electrode pattern part 1121 of the positive electrode plate 112 may be about 10% to about 15% of a thickness (t) of each of the negative electrode plate 111 and the positive electrode plate 112 in the z-axis direction. In some embodiments, the depth of the pattern in the z-axis direction may mean a depth (d₁, d₂) (length) from a virtual reference line of the negative electrode plate 111 and the positive electrode plate 112 up to the most recessed or protruding portion of the pattern. In this specification, the depth (d1, d2) of each pattern in the z-axis direction may be exaggerated to explain the pattern.

In some embodiments, the negative electrode pattern part 1111 and the positive electrode pattern part 1121 may have a plurality of patterns having the same shape and disposed continuously. For example, the negative electrode pattern part 1111 and the positive electrode pattern part 1121 may have uneven patterns having the same shape and disposed continuously.

FIG. 3 illustrates a vertical cross-sectional view of a long side of an electrode assembly 210 of the secondary battery 100 of FIG. 1. Referring to FIG. 3, a concave portion 2111a and a convex portion 2111b of a negative electrode pattern part 2111 and a concave portion 2121a and a convex portion 211b of a positive electrode pattern part 2121 may have a sharply bent triangular shape in addition to (or instead of) the shape in FIG. 2, e.g., a plurality of concave portions and a plurality of convex portions of each of the negative and positive electrode pattern parts 2111 and 2121 may alternate in the y-axis direction to define a continuous wave shape with sharp peaks and valleys.

In some embodiments, the concave portion 2111a and the convex portion 2111b of the negative electrode pattern part 2111 and the concave portion 2121a and the convex portion 2121b of the positive electrode pattern part 2121 may include at least one of an oval, a square, or a polygon in addition to (or instead of) the semicircle or the triangle, or a plurality of shapes in which the above-described shapes are mixed.

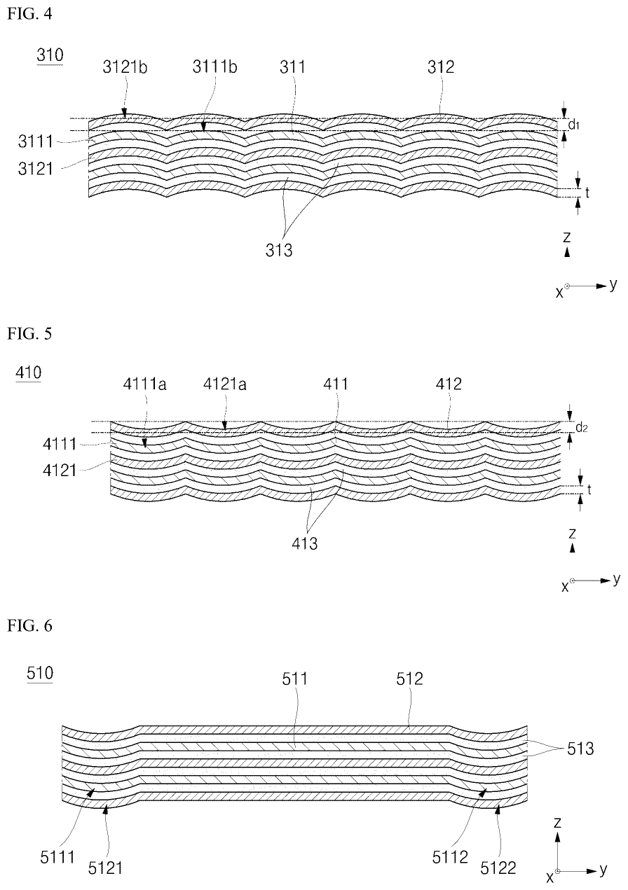

FIG. 4 is a vertical cross-sectional view of a long side of an electrode assembly 310 of the secondary battery 100 of FIG. 1. Referring to FIG. 4, a negative electrode pattern part 3111 and a positive electrode pattern part 3121 may be a plurality of convex patterns (e.g., a plurality of only convex patterns adjacent to each other in the y-axis direction). In some embodiments, the convex pattern may be provided to include a plurality of convex portions 3111b and 3121b protruding in the z-axis direction if viewed in the vertical cross-section of the pair of long sides of the negative electrode plate 311 and the positive electrode plate 312. In addition to the semicircular shape, the convex portions 3111b and 3121b may include a plurality of shapes including at least one of an oval, a triangle, a square, or a polygon, or a mixed shape of the above-described shapes.

FIG. 5 is a vertical cross-sectional view of a long side of an electrode assembly 410 of the secondary battery 100 of FIG. 1. Referring to FIG. 5, a negative electrode pattern part 4111 and a positive electrode pattern part 4121 may be a plurality of concave patterns (e.g., a plurality of only concave patterns adjacent to each other in the y-axis direction). In some embodiments, the concave pattern may be provided to include a plurality of concave portions 4111a and 4121a recessed in the z-axis direction if viewed in the vertical cross-section of the pair of long sides of the negative electrode plate 411 and the positive electrode plate 412. In addition to the semicircular shape, the concave portions 4111a and 4121a may include a plurality of shapes including at least one of an oval, a triangle, a square, or a polygon, or a mixed shape of the above-described shapes.

As illustrated in FIGS. 2 to 5, in the negative electrode pattern parts 1111, 2111, 3111, and 4111 and the positive electrode pattern parts 1121, 2121, 3121, and 4121, respective patterns may be connected continuously, but may be spaced a predetermined distance from each other. For example, the negative electrode pattern parts 1111, 2111, 3111, and 4111 and the positive electrode pattern parts 1121, 2121, 3121, and 4121 may be provided by arranging at least one of a concave pattern, a concave pattern, or a convex pattern continuously or at regular intervals.

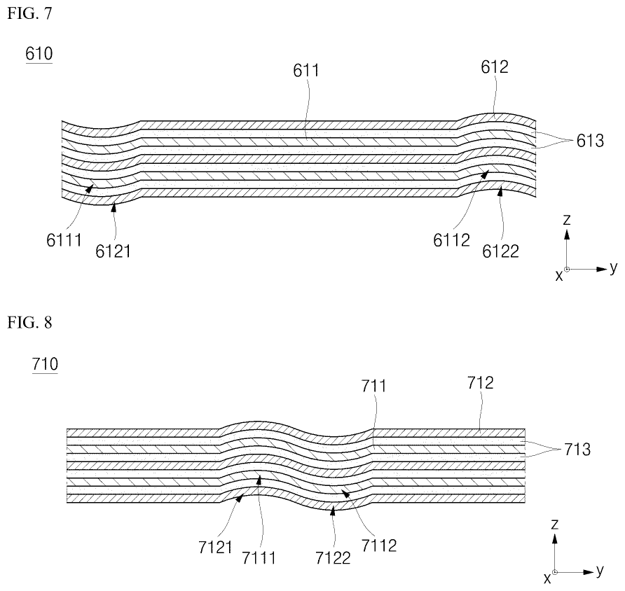

FIGS. 6 and 7 illustrate vertical cross-sectional views of a long side of each of electrode assemblies 510 and 610 of the secondary battery 100 of FIG. 1. Referring to FIGS. 6 and 7, negative electrode plates 511 and 611 and positive electrode plates 512 and 612 may be provided by arranging a plurality of patterns to be spaced apart from each other. In some embodiments, the negative electrode plates 511 and 611 may include first negative electrode pattern parts 5111 and 6111 and second negative electrode pattern parts 5112 and 6112. In some embodiments, the positive electrode plates 512 and 612 may include first positive electrode pattern parts 5121 and 6121 and second positive electrode pattern parts 5122 and 6122.

In some embodiments, the first negative electrode pattern part 5111 and 6111 and the second negative electrode pattern part 5112 and 6112 may be disposed at opposite ends of the negative electrode plates 511 and 611. In some embodiments, the first positive electrode pattern parts 5121 and 6121 and the second positive electrode pattern parts 5122 and 6122 may be disposed at opposite ends of the positive electrode plates 512 and 612.

Referring to FIG. 6, the first negative electrode pattern part 5111 and the second negative electrode pattern part 5112 may have patterns having the same shape (e.g., may be curved in a same direction). In some embodiments, the first positive electrode pattern part 5121 and the second positive electrode pattern part 5122 may have patterns having the same shape (e.g., may be curved in a same direction).

Referring to 7, the first negative electrode pattern part 6111 and the second negative electrode pattern part 5112 may have patterns having different shapes (e.g., may be curved in different directions). For example, the first negative electrode pattern part 6111 may be a concave pattern recessed in the z-axis direction if viewed in a vertical cross-section of a pair of long sides of the negative electrode plate 611. In some embodiments, the second negative electrode pattern part 6112 may be a convex pattern that protrudes in the z-axis direction if viewed from the vertical cross-section of the pair of long sides of the negative electrode plate 611. In some embodiments, the first positive electrode pattern part 6121 and the second positive electrode pattern part 6122 may have patterns having different shapes. For example, the first positive electrode pattern part 6121 may be a concave pattern recessed in the z-axis direction if viewed in a vertical cross-section of a pair of long sides of the positive electrode plate 612. In some embodiments, the second positive electrode pattern part 6122 may be a convex pattern that protrudes in the z-axis direction if viewed from the vertical cross-section of the pair of long sides of the positive electrode plate 612.

FIG. 8 is a vertical cross-sectional view of a long side of an electrode assembly 710 of the secondary battery 100 according to FIG. 1. Referring to FIG. 8, a first negative electrode pattern part 7111 and a second negative electrode pattern part 7112 of a negative electrode plate 711, and a first positive electrode pattern part 7121 and a second positive electrode pattern part 7122 of a positive electrode plate 712 may be disposed at central areas of the negative electrode plate 711 and the positive electrode plate 712, respectively. In some embodiments, the first negative electrode pattern part 7111 and the second negative electrode pattern part 7112 may have patterns having the same shape. In some embodiments, the first negative electrode pattern part 7111 and the second negative electrode pattern part 7112 may have patterns having different shapes. In some embodiments, the first positive electrode pattern part 7121 and the second positive electrode pattern part 7122 may have patterns having the same shape. In some embodiments, the first positive electrode pattern part 7121 and the second positive electrode pattern part 7122 may have patterns having different shapes.

In some embodiments, the first negative electrode pattern part 7111 and the second negative electrode pattern part 7112, and the first positive electrode pattern part 7121 and the second positive electrode pattern part 7122 may include a shape of at least one of a semicircle, an oval, a triangle, a square, or a polygon, or at least one of shapes in which the above-described shapes are mixed. In some embodiments, the first negative electrode pattern part 7111 and the second negative electrode pattern part 7112, and the first positive electrode pattern part 7121 and the second positive electrode pattern part 7122 may be continuous or spaced apart from each other.

As described above, if applying the stacking method of the electrode assembly 110, a structural design for securing an alignment between the negative electrode plate 111 and the positive electrode plate 112 is very important. Typically, the stacked electrode plates may be transferred using a precision robot to secure the alignment and may measure the alignment state using an optical camera. However, if the high-precision robot for inspecting the alignment and the optical camera for inspecting the alignment are used, a time and costs required for manufacturing the electrode assembly 110 may increase. In some embodiments, the alignment may be secured by physically restricting the alignment between the positive and negative electrodes by giving slight bending (or folding) to the electrode plate itself so that the alignment is not disturbed.

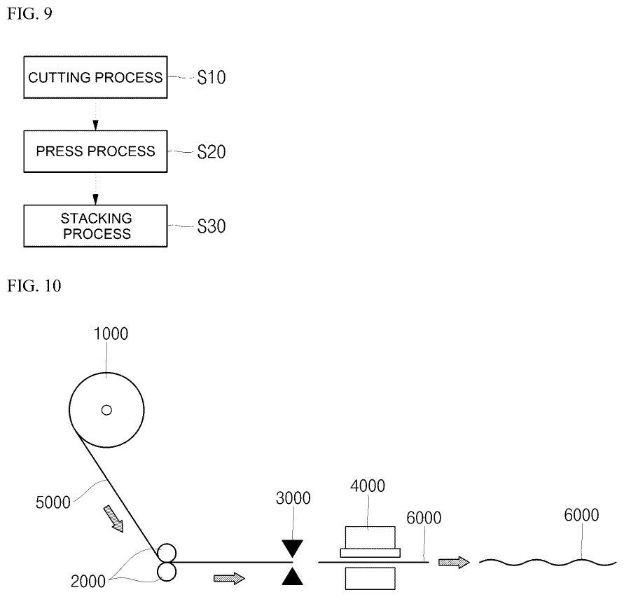

For example, referring to FIGS. 9 and 10 below, a process of bending the electrode plate itself may be introduced within force that does not affect characteristics of the electrode plate after notching and cutting the electrode plate to secure the alignment between the positive/negative electrodes, and even in a formation process after the stacking, because the movement of the electrode plate is restricted, the alignment may be secured. Therefore, in the present disclosure, the maintenance of the stacked arrangement may be reinforced, and a downgrade of specifications of the precision robot for transferring the stacked electrode plates and a deterioration of a vision inspection function may be enabled to reduce the costs and time required for maintaining the stacked arrangement.

FIG. 9 illustrates a flowchart of a method for manufacturing an electrode assembly according embodiments. FIG. 10 illustrates a view for explaining the method for manufacturing the electrode assembly according to embodiments. Referring to FIG. 9, the method for manufacturing an electrode assembly according to embodiments may include a cutting process (S10), a press process (S20), and a stacking process (S30). Referring to FIG. 10, an example of a stacking device for manufacturing the electrode assembly is illustrated.

First, as illustrated in FIGS. 9 and 10, in the cutting process (S10), a base material 5000 may be cut to roughly correspond to a size of the electrode assembly to be manufactured. In some embodiments, the base material 5000 may be provided from a supply roll 1000 and cut at a cutting part 3000 via a transfer roller 2000. In some embodiments, the base material 5000 may be cut using a laser or the like. The supply roll 1000 may be a roll on which the base material 5000 that will form a current collector is wound. For example, if a device for manufacturing an electrode assembly according to embodiments manufactures a positive electrode plate, the base material 5000 may be metal foil containing aluminum (Al) to become a positive electrode current collector. In some embodiments, if the device for manufacturing the electrode assembly according to embodiments manufactures a negative electrode plate, the base material 5000 may be metal foil containing copper (Cu) or nickel (Ni) to become a negative electrode current collector. However, the material of the current collector may be made of other materials.

In some embodiments, the transfer roller 2000 may be an idle roller that guides the base material 5000 unwound from the supply roll 1000 or a drive roller that applies tension to unwind the base material 5000. In some embodiments, in the latter case, the transfer roller 2000 may form a transfer part that unwinds and transfers the base material 5000. Although two transfer rollers 2000 are illustrated in FIG. 10, this is only an example, and thus, the number of transfer rollers and positions of the transfers may be changed as necessary. Although omitted in the present disclosure, a coating part may be further provided to apply slurry that is prepared in advance on the base material 5000, thereby forming a coating layer. The slurry to be coated here may contain an active material. For example, if the device for manufacturing the electrode assembly according to embodiments is used to manufacture the positive electrode plate, the slurry may contain an active material including transition metal oxide, a binder, a volatile solvent, etc. Even if manufacturing the negative electrode plate, slurry may be prepared with an active material including transition metal oxide, a binder, a solvent, etc.

In the press process (S20), the electrode plate 6000 (hereinafter, referred to as the electrode plate because it is coated with an active material) may be pressed by a pressing part 4000 to form a pattern part on the electrode plate 6000. In some embodiments, the pressing part 4000 may form a pattern part on the electrode plate 6000 by performing rolling at room temperature or a high temperature of about 70° C. or less using a jig on which a pattern is formed. For example, the pressing part 4000 may be implemented as a roller press, a surface press, etc.

In the stacking process (S30), the stacked electrode plates may be seated on a pressing press and then be pressed. The electrode assembly formed by stacking a negative electrode plate, a positive electrode plate, and a separator, which is inserted between the negative electrode plate and the positive electrode plate, may be seated on the pressing press. In some embodiments, FIG. 10 illustrates a process of manufacturing the positive or negative electrode plate, and the corresponding process may be performed on each of the positive and negative electrode plates. In some embodiments, after the process illustrated in FIG. 10, the pressing press may press the electrode assembly so that the positive electrode plate, the separator, and the negative electrode plate are in close contact with each other. At this time, heat having a certain temperature may be applied to the pressing press. Therefore, if the electrode assembly is pressed by the pressing press, adhesion force between the positive and negative electrode plates and the separator may increase by heat to suppress movement of the electrode plates and prevent deformation of the electrode assembly.

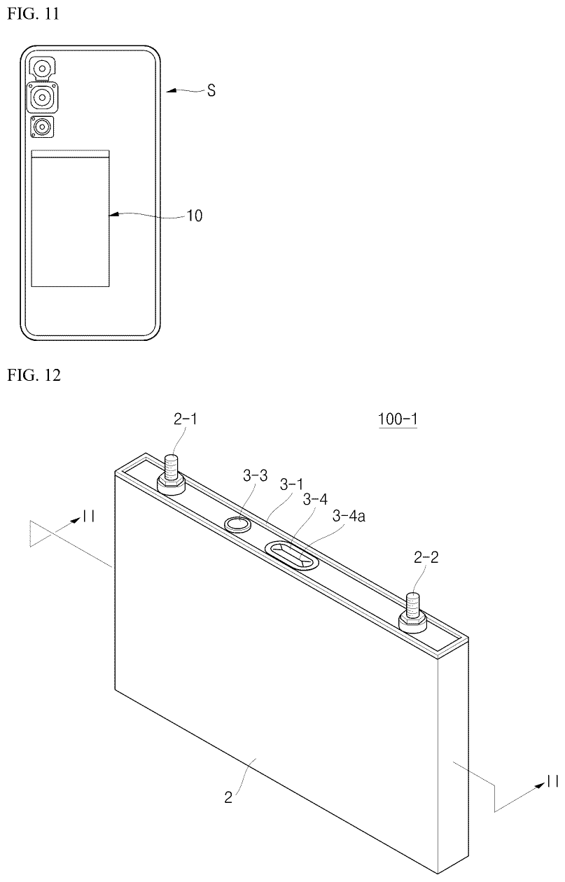

FIG. 11 is a view schematically showing a smartphone equipped with a secondary battery according to an embodiment of the present disclosure. As shown in FIG. 11, a secondary battery 10 according to the above-described embodiment of the present disclosure may be a small battery mounted in a small portable device such as a smartphone S. In this case, because the exemplary secondary battery 10 is configured to be able to increase the capacity thereof while having a slim internal structure, the above-described secondary battery 10 may be a battery suitable for application to small portable devices. As used herein, the terms “secondary battery” and “battery” have the same meaning and are different only in expression for convenience of description.

The secondary battery according to the above-described embodiment may be increased in size to be used to manufacture a battery pack. In some embodiments, the electrode assembly 110 described above may also be applied to a prismatic type secondary battery 100-1 illustrated in FIGS. 11 and 12.

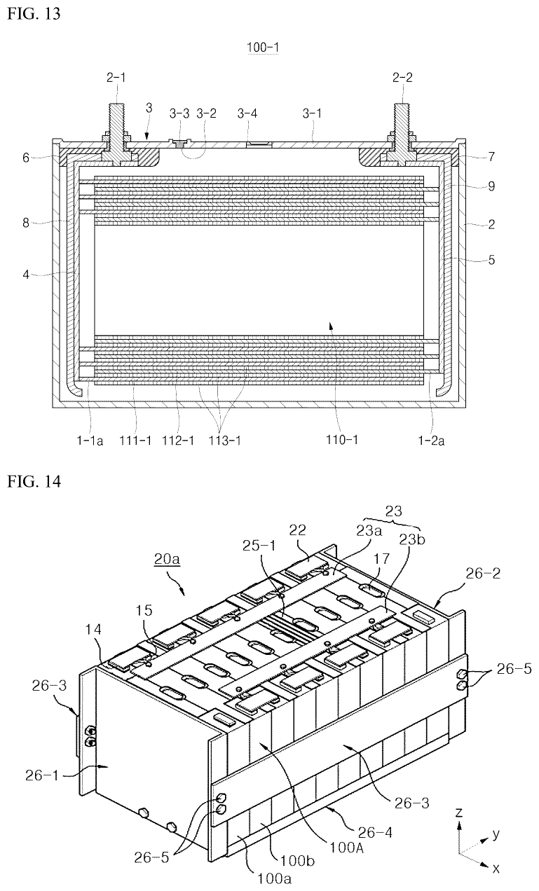

FIG. 12 is a perspective view illustrating a secondary battery 100-1 according to one or more embodiments of the present disclosure, and FIG. 13 is a cross-sectional view taken along the line II-II in FIG. 12.

Referring to FIGS. 12 and 13, the secondary battery 100-1 according to one or more embodiments of the present disclosure may include at least one electrode assembly 110-1 wound with a separator 113-1 as an insulator between the negative electrode 111-1 and the positive electrode 112-1, a case 2 in which the electrode assembly 110-1 is received (or accommodated) therein, and a cap assembly 3 coupled to an opening of the case 2.

The secondary battery 100-1 according to one or more embodiments will now be described as an example of a prismatic lithium ion secondary battery. However, the present disclosure is not limited thereto, and suitable aspects, features and principles described herein may be applied to various other types of batteries, such as lithium polymer batteries and/or cylindrical batteries.

Each of the negative electrode 111-1 and the positive electrode 112-1 may include a current collector made of a thin metal foil having a coated portion on which an active material is coated and an uncoated portion 1-1a, 1-2a on which an active material is not coated.

The negative electrode 111-1 and the positive electrode 112-1 are wound after interposing the separator 113-1, which is an insulator, therebetween. However, the present disclosure is not limited thereto, and the electrode assembly 110-1 may have a structure in which the negative electrode 111-1 and the positive electrode 112-1, each made of a plurality of sheets, are alternately stacked with a separator interposed therebetween.

The case 2 may form the overall outer appearance of the secondary battery 100-1 and may be made of a conductive metal, such as aluminum, aluminum alloy, or nickel-plated steel. In addition, the case 2 may provide a space in which the electrode assembly 110-1 is accommodated.

The cap assembly 3 may include a cap plate 3-1 covering an opening in the case 2, and the case 2 and the cap plate 3-1 may be made of a conductive material. The negative electrode terminal 111-1 and the positive terminal 112-1 electrically connected to the negative electrode 2-1 and the positive electrode 2-2, respectively, may be installed to penetrate (or extend through) the cap plate 3-1 and protrude outwardly therethrough.

In addition, outer peripheral surfaces (e.g., circumferential surfaces) of upper pillars of the negative and positive electrode terminals 2-1 and 2-2 protruding outwardly from the cap plate 3-1 may be threaded and may be fixed to the cap plate 3-1 by utilizing nuts.

However, the present disclosure is not limited thereto, and the negative and positive electrode terminals 2-1 and 2-2 may have a rivet structure and may be riveted or welded to the cap plate 3-1.

In addition, the cap plate 3-1 may be made of a thin plate and may be coupled to the opening in the case 2, and an electrolyte injection port 3-2 into which a sealing stopper 3-3 may be installed may be located (e.g., formed) in the cap plate 3-1, and a vent portion 3-4 having a notch 3-4a may be installed.

The negative and positive electrode terminals 2-1 and 2-2 may be electrically connected to current collectors including first and second current collectors 4 and 5 (hereinafter referred to as positive and negative current collectors) by being bonded or coupled (e.g., by welding) to the negative uncoated portion 1-1a and the positive electrode uncoated portion 1-2a, respectively.

For example, the negative and positive electrode terminals 2-1 and 2-2 may be coupled by welding to the negative and positive electrode current collectors 4 and 5, respectively. However, the present disclosure is not limited thereto, and the negative and positive electrode terminals 2-1 and 2-2 and the negative and positive electrode current collectors 4 and 5 may be integrally formed in one or more embodiments.

In addition, an insulation member may be installed between the electrode assembly 110-1 and the cap plate 3-1. The insulation member may include first and second lower insulation members 6 and 7, and each of the first and second lower insulation members 6 and 7 may also have a portion located between the electrode assembly 110-1 and the cap plate 3-1.

In addition, according to one or more embodiments of the present disclosure, one end of a separation member may face one side of the electrode assembly 110-1 and may be installed between the insulation member and the negative or positive electrode terminals 2-1 and 2-2.

In one or more embodiments, the separation member may include first and second separation members 8 and 9.

In such an embodiment, first ends of the first and second separation members 8 and 9 installed to face one side of the electrode assembly 110-1 may be respectively installed between the first and second lower insulation members 6 and 7 and the negative and positive electrode terminals 2-1 and 2-2.

Accordingly, the negative and positive electrode terminals 2-1 and 2-2, which may be coupled by welding to the negative and positive electrode current collectors 4 and 5, may be coupled to first ends of the first and second lower insulation members 6 and 7 and the first and second separation members 8 and 9.

A battery pack according to one or more embodiments includes at least one battery module and a pack housing having an accommodation space in which the at least one battery module is accommodated.

The battery module may include a plurality of battery cells and a module housing. The battery cells may be accommodated inside the module housing in a stacked form (or stacked arrangement or configuration). Each battery cell may have a positive electrode terminal and a negative electrode terminal and may be a circular type, a prismatic type, or a pouch type according to the shape of battery. In the present specification, a battery cell may also be referred to as a secondary battery, a battery, or a cell.

In the battery pack, one cell stack may constitute one module stacked in place of the battery module. The cell stack may be accommodated in an accommodation space of the pack housing or may be accommodated in an accommodation space partitioned by a frame, a partition wall, etc.

The battery cell may generate a large amount of heat during charging/discharging. The generated heat may be accumulated in the battery cell, thereby accelerating the deterioration of the battery cell. Accordingly, the battery pack may further include a cooling member to remove the generated heat and thereby suppress deterioration of the battery cell. The cooling member may be provided at the bottom of the accommodation space at where the battery cell is provided but is not limited thereto and may be provided at the top or side depending on the battery pack.

The battery cell may be configured such that exhaust gas generated inside the battery cell under abnormal operating conditions, also known as thermal runaway or thermal events, is discharged to the outside of the battery cell. The battery pack or the battery module may include an exhaust port for discharging the exhaust gas to prevent or reduce damage to the battery pack or module by the exhaust gas.

The battery pack may include a battery and a battery management system (BMS) for managing the battery. The battery management system may include a detection device, a balancing device, and a control device. The battery module may include a plurality of cells connected to each other in series and/or parallel. The battery modules may be connected to each other in series and/or in parallel.

The detection device may detect a state of a battery (e.g., voltage, current, temperature, etc.) to output state information indicating the state of the battery. The detection device may detect the voltage of each cell constituting the battery or of each battery module. The detection device may detect current flowing through each battery module constituting the battery module or the battery pack. The detection device may also detect the temperature of a cell and/or module on at least one point of the battery and/or an ambient temperature.

The balancing device may perform a balancing operation of a battery module and/or cells constituting the battery module. The control device may receive state information (e.g., voltage, current, temperature, etc.) of the battery module from the detection device. The control device may monitor and calculate the state of the battery module (e.g., voltage, current, temperature, state of charge (SOC), life span (state of health (SOH)), etc.) on the basis of the state information received from the detection device. In addition, on the basis of the monitored state information, the control device may perform a control function (e.g., temperature control, balancing control, charge/discharge control, etc.) and a protection function (e.g., over-discharge, over-charge, over-current protection, short circuit, fire extinguishing function, etc.). In addition, the control device may perform a wired or wireless communication function with an external device of the battery pack (e.g., a higher level controller or vehicle, charger, power conversion system, etc.).

The control device may control charging/discharging operation and protection operation of the battery. To this end, the control device may include a charge/discharge control unit, a balancing control unit, and/or a protection unit.

The battery management system is a system that monitors the battery state and performs diagnosis and control, communication, and protection functions, and may calculate the charge/discharge state, calculate battery life or state of health (SOH), cut off, as necessary, battery power (e.g., relay control), control thermal management (e.g., cooling, heating, etc.), perform a high-voltage interlock function, and/or may detect and/or calculate insulation and short circuit conditions.

A relay may be a mechanical contactor that is turned on and off by the magnetic force of a coil or a semiconductor switch, such as a metal oxide semiconductor field effect transistor (MOSFET).

The relay control has a function of cutting off the power supply from the battery if (or when) a problem occurs in the vehicle and the battery system and may include one or more relays and pre-charge relays at the positive terminal and the negative terminal, respectively.

In the pre-charge control, there is a risk of inrush current occurring in the high-voltage capacitor on the input side of the inverter when the battery load is connected. Thus, to prevent inrush current when starting a vehicle, the pre-charge relay may be operated before connecting the main relay and the pre-charge resistor may be connected.

The high-voltage interlock is a circuit that uses a small signal to detect whether or not all high-voltage parts of the entire vehicle system are connected and may have a function of forcibly opening a relay if (or when) an opening occurs at even one location on the entire loop.

FIG. 14 is a perspective view illustrating a battery module 20a according to one or more embodiments of the present disclosure. Referring to FIG. 14, the battery module 20a according to one or more embodiments of the present disclosure includes terminal parts 14 and 15, a plurality of battery cells 100A arranged in one direction, a connection tab 22 connecting a battery cell 100a to an adjacent battery cell 100b, and a protection circuit module 23 having one end connected to the connection tab 22. The protection circuit module 23 may include a battery management system (BMS). Further, the connection tab 22 may include a body portion in contact with the terminal parts 14 and 15 between the adjacent battery cells 100a and 100b and an extension portion extending from the body portion and connected to the protection circuit module 23. The connection tab 22 may be, for example, a bus bar.

Each battery cell 100A may include a battery case, an electrode assembly received (or accommodated) in the battery case, and an electrolyte. The electrode assembly and the electrolyte react electrochemically to store and release (e.g., generate) energy. The terminal parts 14 and 15 electrically connected to the connection tab 22 and a vent 17 as a discharge passage for gas generated inside the battery case may be provided on one side of (e.g., an upper side of) the battery cell 100A. The terminal parts 14 and 15 of the battery cell 100A may be a positive electrode terminal 14 and a negative electrode terminal 15 having different polarities from each other, and the terminal parts 14 and 15 of the adjacent battery cells 100a and 100b may be electrically connected to each other in series or parallel by the connection tab 22, to be described in more detail below. Although a serial connection has been described as an example, the connection structure is not limited thereto, and various connection structures may be employed as desired or necessary. In addition, the number and arrangement of battery cells is not limited to the structure shown in FIG. 14 and may be changed as desired or necessary.

The plurality of battery cells 100A may be arranged in (e.g., may be stacked in) one direction so that the wide surfaces of the battery cells 100A face each other, and the plurality of battery cells 100A may be fixed by the housings 26-1, 26-2, 26-3, and 26-4. The housings 26-1, 26-2, 26-3, and 26-4 may include a pair of end plates 26-1 and 26-2 facing the wide surfaces of the battery cell 100A and a side plate 26-3 and a bottom plate 26-4 connecting the pair of end plates 26-1 and 26-2 to each other. The side plate 26-3 may support side surfaces of the battery cells 100A, and the bottom plate 26-4 may support bottom surfaces of the battery cells 100A. In addition, the pair of end plates 26-1 and 26-2, the side plate 26-3 and the bottom plate 26-4 may be connected by bolts 26-5 and/or any other suitable fastening members and methods known to those of ordinary skill in the art.

The protection circuit module 23 may have electronic components and protection circuits mounted thereon and may be electrically connected to connection tabs 22, to be described in more detail later. The protection circuit module 23 includes a first protection circuit module 23a and a second protection circuit module 23b extending along the direction in which the plurality of battery cells 100A are arranged in different locations. The first protection circuit module 23a and the second protection circuit module 23b may be spaced from each other at a suitable interval (e.g., a predetermined interval) and arranged parallel to each other to be electrically connected to adjacent connection tabs 22, respectively. For example, the first protection circuit module 23a extends on one side of the upper portion of the plurality of battery cells 100A along the direction in which the plurality of battery cells 100A are arranged, and the second protection circuit module 23b extends to the other upper side of the plurality of battery cells 100A along the direction in which the plurality of battery cells 100A are arranged. The second protection circuit module 23b may be spaced from the first protection circuit module 23a at a suitable interval (e.g., a predetermined interval) with the vents 17 interposed therebetween but may be disposed parallel to the first protection circuit module 23a. As such, the two protection circuit modules are spaced from each other side-by-side along the direction in which the plurality of battery cells 100A are arranged, thereby reducing or minimizing the area of the printed circuit board (PCB) constituting the protection circuit module. By separately configuring the protection circuit module into two protection circuit modules, unnecessary PCM area can be reduced or minimized. In addition, the first protection circuit module 23a and the second protection circuit module 23b may be connected to each other by a conductive connection member 25-1. One side of the conductive connection member 25-1 is connected to the first protection circuit module 23a, and the other side thereof is connected to the second protection circuit module 23b so that the two protection circuit modules 23a and 23b can be electrically connected with each other.

The connection may be performed by any one of soldering, resistance welding, laser welding, projection welding and/or any other suitable connection methods known to those of ordinary skill in the art.

In addition, the connection member 25-1 may be, for example, an electric wire. In addition, the connection member 25-1 may be made of a material having elasticity or flexibility. By the connecting member 25-1, it may be possible to check and manage whether the voltage, temperature, and/or current of the plurality of battery cells 100A are normal. For example, the information received by the first protection circuit module from connection tabs adjacent to the first protection circuit module, such as voltage, current, and/or temperature, and the information received from connection tabs adjacent to the second protection circuit module, such as voltage, current, and/or temperature, may be integrated and managed by the protection circuit module through the connection member 25-1.

In addition, when the battery cell 100A swells, shocks may be absorbed by the elasticity or flexibility of the connection member 25-1, thereby preventing the first and second protection circuit modules 23a and 23b from being damaged.

In addition, the shape and structure of the connection member 25-1 is not limited to the shape and structure shown in FIG. 14.

As described above, because the protection circuit module 23 is provided as the first and second protection circuit modules 23a and 23b, the area of the PCB constituting the protection circuit module can be reduced or minimized, and the space inside the battery module can be secured, which improves work efficiency by facilitating a fastening work for connecting the connection tab 22 and the protection circuit module 23 and repair work if (or when) an abnormality is detected in the battery module.

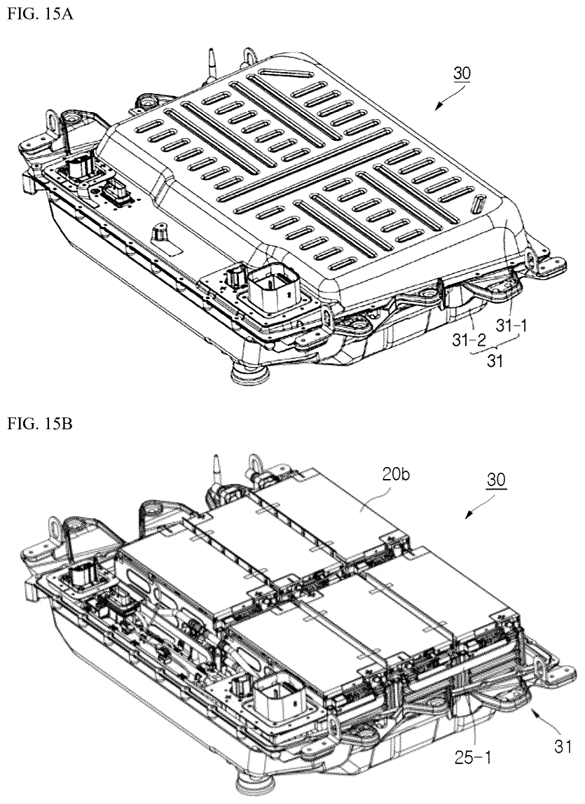

FIGS. 15A and 15B illustrate perspective views of an example of a battery pack 30. The battery pack 30 may include a plurality of battery modules 20b and a housing 31 for accommodating the plurality of battery modules 20b. For example, the housing 31 may include first and second housings 31-1 and 31-2 coupled in opposite directions through the plurality of battery modules 20b. The plurality of battery modules 20b may be electrically connected to each other by using a bus bar 25-1, and the plurality of battery modules 20b may be electrically connected to each other in a series/parallel or series-parallel mixed method, thereby obtaining desired (e.g., required) electrical output.

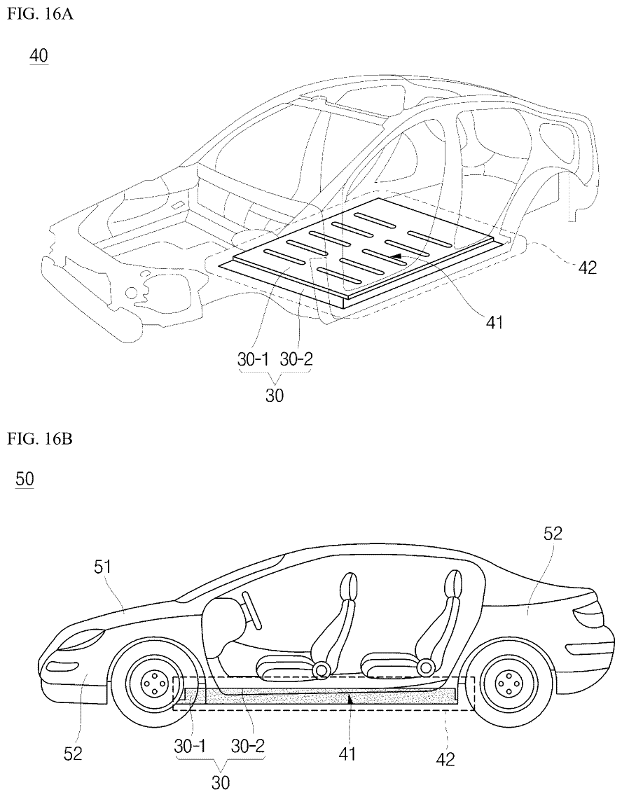

FIGS. 16A and 16B illustrate perspective and side views of examples of a vehicle body 40 and a vehicle components.

In FIG. 16A, a battery pack 30 may include a battery pack cover 30-1, which is a part of a vehicle underbody 41, and a pack frame 30-2 located under the vehicle underbody 41. In some examples, the battery pack cover 30-1 may correspond to the first housing 31-1, and the pack frame 30-2 may correspond to the second housing 31-2. The pack frame 30-2 and the battery pack cover 30-1 may be integrally formed with a vehicle floor 42. The vehicle underbody 41 separates the inside and outside of a vehicle, and the pack frame 30-2 may be located outside the vehicle.

Referring to FIG. 16B, a vehicle 50 may be formed by combining additional parts, such as a hood 51 in front of the vehicle and fenders 52 respectively located in the front and rear of the vehicle to a vehicle body 40.

The vehicle 50 may include the battery pack 30 that include the battery pack cover 30-1 and the pack frame 30-2, and the battery pack 30 may be coupled to the vehicle body 40.

By way of summation and review, aspects of some embodiments of the present disclosure provide an electrode assembly for a secondary battery, which enables an alignment of electrode plates to be more easily maintained during a stacking process of the electrode assembly, and a method for manufacturing the same. That is, according to the present disclosure, in the stacking process of the electrode assembly, a curve (or a bend) may be provided on each electrode plate itself to secure the alignment between the positive electrode and the negative electrode, thereby more easily maintaining the alignment of the electrode plates and reducing the time and costs, which are required for maintaining and inspecting the alignment.

These and other aspects and features of the present disclosure will be apparent from the preceding description of embodiments of the present disclosure.

Although the present disclosure has been described with reference to embodiments and drawings illustrating aspects thereof, the present disclosure is not limited thereto. Various modifications and variations can be made by a person skilled in the art to which the present disclosure belongs within the scope of the present disclosure and the claims and their equivalents, below.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated.

Accordingly, it will be understood by those of skill in the art that various changes in form and details may be made without departing from the scope of the present invention as set forth in the following claims.

What is claimed is:

1. An electrode assembly for a secondary battery, comprising:
a first electrode plate with a first electrode pattern part, the first electrode pattern part including a plurality of patterns;
a second electrode plate with a second electrode pattern part, the second electrode being stacked on at least one surface of the first electrode plate, and the second electrode pattern part including a plurality of patterns corresponding to positions and shapes of the plurality of patterns of the first electrode pattern part; and
a separator between the first electrode plate and the second electrode plate.

2. The electrode assembly as claimed in claim 1, wherein the separator is pressed between the first electrode plate and the second electrode plate, the separator having a shape corresponding to the plurality of patterns of each of the first electrode pattern part and the second electrode pattern part.

3. The electrode assembly as claimed in claim 1, wherein each of the first electrode pattern part and the second electrode pattern part includes an uneven pattern.

4. The electrode assembly as claimed in claim 3, wherein each of the first electrode pattern part and the second electrode pattern part includes a plurality of concave portions and a plurality of convex portions, respectively.

5. The electrode assembly as claimed in claim 4, wherein each of the plurality of concave portions and the plurality of convex portions has a shape of at least one of a semicircle, an oval, a triangle, a square, or a polygon.

6. The electrode assembly as claimed in claim 4, wherein each of the plurality of concave portions and the plurality of convex portions has a shape in which at least two of a semicircle, an oval, a triangle, a square, or a polygon are mixed.

7. The electrode assembly as claimed in claim 1, wherein each of the first electrode pattern part and the second electrode pattern part includes a plurality of concave patterns or a plurality of convex patterns, respectively.

8. The electrode assembly as claimed in claim 1, wherein the plurality of patterns in each of the first electrode pattern part and the second electrode pattern part are arranged in a continuous shape.

9. The electrode assembly as claimed in claim 1, wherein the plurality of patterns in each of the first electrode pattern part and the second electrode pattern part are spaced apart from each other.

10. The electrode assembly as claimed in claim 9, wherein the plurality of patterns spaced apart from each other in each of the first electrode pattern part and the second electrode pattern part have shapes different from each other.

11. The electrode assembly as claimed in claim 1, wherein a depth of each of the plurality of patterns in each of the first electrode pattern part and the second electrode pattern part is about 10% to about 15% of a thickness of each of the first electrode plate and the second electrode plate.

12. A method for manufacturing an electrode assembly for a secondary battery, the method comprising:
cutting a first electrode plate and a second electrode plate in each of a first base material and a second base material;
pressing the first electrode plate and the second electrode plate to form a first electrode pattern part and a second electrode pattern part, such that each of the first electrode pattern part and the second electrode pattern part has a plurality of patterns;
stacking the second electrode plate on at least one surface of the first electrode plate, such that the first electrode pattern part and the second electrode pattern part correspond to each other in position and shape of the plurality of patterns and such that a separator is inserted between the first electrode plate and the second electrode plate, to stack the first electrode plate, the second electrode plate, and the separator.

13. The method as claimed in claim 12, wherein pressing the first electrode plate and the second electrode plate includes forming a plurality of uneven patterns on each of the first electrode pattern part and the second electrode pattern part.

14. The method as claimed in claim 13, wherein forming the plurality of uneven patterns on each of the first electrode pattern part and the second electrode pattern part includes forming a plurality of concave portions and/or a plurality of convex portions, respectively.

15. The method as claimed in claim 14, wherein forming the plurality of concave portions and/or the plurality of convex portions includes forming a shape of at least one of a semicircle, an oval, a triangle, a square, or a polygon.

16. The method as claimed in claim 14, wherein forming the plurality of concave portions and/or the plurality of convex portions includes forming a shape in which at least two of a semicircle, an oval, a triangle, a square, or a polygon are mixed.

17. The method as claimed in claim 12, wherein pressing the first electrode plate and the second electrode plate includes forming a plurality of concave patterns or a plurality of convex patterns in/on each of the first electrode pattern part and the second electrode pattern part.

18. The method as claimed in claim 12, wherein pressing the first electrode plate and the second electrode plate includes continuously forming a plurality of on each of the first electrode pattern part and the second electrode pattern part.

19. The method as claimed in claim 12, wherein pressing the first electrode plate and the second electrode plate includes forming a plurality of patterns to be spaced apart from each other on each of the first electrode pattern part and the second electrode pattern part.

20. The method as claimed in claim 12, wherein pressing the first electrode plate and the second electrode plate includes performed pressing so that a depth of each of the plurality of patterns of each of the first electrode pattern part and the second electrode pattern part is about 10% to about 15% of a thickness of each of the first electrode plate and the second electrode plate.
